(19) United States
(12) Patent Application Publication
(10) Pub. No.: US 2010/0154777 A1
(43) Pub. Date: Jun. 24, 2010

(54) REGULATION VALVE

(75) Inventors: Johnny Leonardo Carvalho, Taubate (BR); Kléber Luiz da Silva, Taubate (BR)

Correspondence Address: Berenbaum Weinshienk PC, 370 Seventeenth Street, Republic Plaza, Suite 4800, Denver, CO, 80202, US

(73) Assignee: Coprecitec, S.L., Aretxabaleta Gipuzkoa (ES)

(21) Appl. No.: 12/642,661

(22) Filed: Dec. 18, 2009

(30) Foreign Application Priority Data
Dec. 19, 2008 (ES) U200802600

(51) Int. Cl. F24C 3/00; F24C 3/12; F16K 5/04; F16K 51/00

(52) U.S. Cl. 126/39 E; 251/207; 251/286

(57) ABSTRACT

A regulation valve having a valve body, a rotary regulatory body and a drive shaft attached to the regulatory body. The rotary regulatory body is housed in the valve body and has a plurality of inlet orifices that may be positioned to face a gas inlet by rotating the regulatory body by use of the drive shaft. A first inlet orifice corresponds to a first minimum flow of a first type of gas, and a second inlet orifice corresponds to a second minimum flow of a second type of gas. The first and second inlet orifices situated in the regulatory body at different angular positions. The drive shaft and the valve body have cooperating features that limit the angular rotation of the regulatory body to a second angular position where the second inlet orifice is aligned to face the gas inlet. Attached to, or incorporated into the regulation valve, is a stop element which can be arranged in an active position or in a rest position. In the active position the stop element interacts with a feature of the drive shaft to limit the angular rotation of the regulatory body to a first angular position where the first inlet orifice is aligned to face the gas inlet, the first angular position preceding the second angular position. In the rest position, the stop element does not limit the angular rotation of the regulatory body to the first angular position, thereby permitting the regulatory body to be rotated to the second angular position.

### CROSS-REFERENCE TO RELATED APPLICATIONS

This application claims priority to and the benefit of Spanish Utility Model Application No. U200802600, filed Dec. 19, 2008.

### TECHNICAL FIELD

The present invention relates to gas valves adapted for use with different types of fuels.

### BACKGROUND

Gas valves are known for domestic cooking appliances using a single valve for regulating the flow of two different types of gas such as natural gas (NG) and liquefied petroleum gas (LPG).

Spanish Utility Model Application Publication No. ES1059642U describes a gas valve for a gas burning appliance, such as a domestic cooking appliance, having a regulatory body coupled to a drive shaft. In one embodiment, a rotary control knob attached to the drive shaft establishes an angular limit position that determines a minimum flow of a gas passing through the valve which is dependent on the type of gas (e.g., natural gas (NG) or liquid petroleum gas (LPG)) being delivered through the tap.

### SUMMARY OF THE DISCLOSURE

An object of the present invention is to provide a regulation valve for gas burning appliances, such as cooking appliances, that is adapted for regulating the flow of two different types of gas such as NG and LPG.

In accordance with one embodiment the regulation valve includes a valve body, a rotary regulatory body and a drive shaft attached to the regulatory body. The rotary regulatory body is housed in the valve body and has a plurality of inlet orifices that may be positioned to face a gas inlet by rotating the regulatory body by use of the drive shaft. A first inlet orifice corresponds to a first minimum flow of a first type of gas, and a second inlet orifice corresponds to a second minimum flow of a second type of gas. The first and second inlet orifices situated in the regulatory body at different angular positions.

The drive shaft and the valve body have cooperating features that limit the angular rotation of the regulatory body to a second angular position where the second inlet orifice is aligned to face the gas inlet. Attached to, or incorporated into the regulation valve, is a stop element which can be arranged in an active position or in a rest position. In the active position the stop element interacts with a feature of the drive shaft to limit the angular rotation of the regulatory body to a first angular position where the first inlet orifice is aligned to face the gas inlet, the first angular position preceding the second angular position. In the rest position, the stop element does not limit the angular rotation of the regulatory body to the first angular position, thereby permitting the regulatory body to be rotated by the drive shaft to the second angular position. In one implementation, the first angular position establishes a minimum flow rate of NG through the regulation valve and the second angular position establishes a minimum flow rate of LPG through the regulation valve.

Accordingly, by varying the position of the stop element, a single regulation valve may be used to regulate the flow of gas to a gas burning appliance regardless of the type of fuel used, thus avoiding a complicated adjustment of a minimum flow (Qₘᵢₙ).

### BRIEF DESCRIPTION OF THE DRAWINGS

Alternative implementations of the present disclosure are disclosed herein with at least partial reference to the drawings wherein:

FIG. 1 is a perspective view of a regulation valve of one embodiment of the present invention.

FIG. 2 is a cross-sectional view of the regulation valve of FIG. 1.

FIG. 3 illustrates a cross-sectional view of a stop element in one embodiment, the stop element being in an active position.

FIG. 4 illustrates a cross-sectional view of a cross section of the stop element of FIG. 3, the stop element being in a rest position.

FIG. 5 is a detailed view of the cross section V-V of FIG. 2.

### DETAILED DESCRIPTION

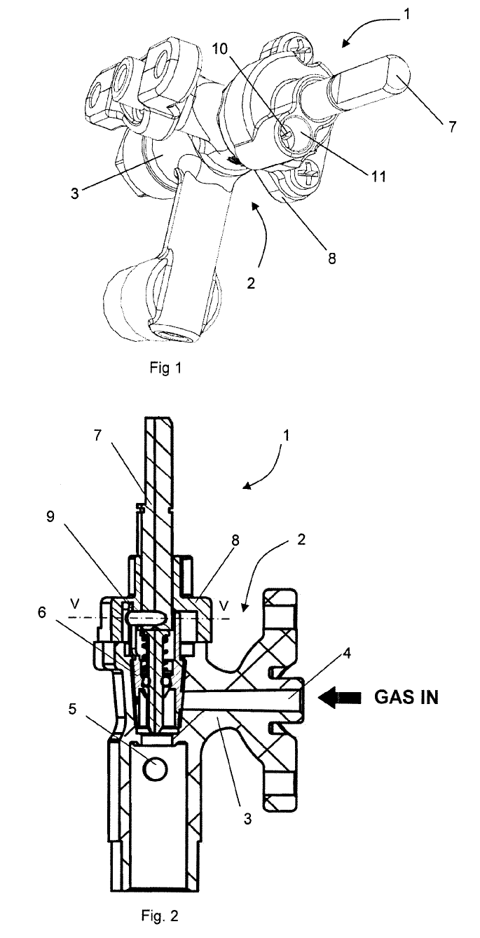

With reference to FIGS. 1 and 2, a regulation valve 1 for a gas burning appliance according to one embodiment of the present invention is illustrated. The regulation valve 1 includes a valve body 2, a rotary regulatory body 6, and a drive shaft 7 attached to the rotary regulatory body 6. In one implementation, the valve body 2 comprises a main body 3 and a cover 8. On the cover 8 is arrange a housing 11 in which is located a stop element 10. The regulatory body 6 is housed in the valve body 2 and has a plurality of inlet orifices that by turning the regulatory body 6, the inlets orifices are faced with a gas inlet 4 to provide a flow “Q” through an outlet 5 which is directed to a gas burner (not shown in the drawings). Among the plurality of inlet orifices there is a first radial inlet orifice for establishing a first minimum flow corresponding to a first type of gas, and a second radial inlet orifice for establishing a second minimum flow corresponding to a second type of gas. In one implementation, the first and second radial inlet orifices are arranged in adjacent first and second angular positions, respectively, with the first angular position preceding the second angular position.

In one embodiment, the drive shaft 7 has a radially extending projection 9 that cooperates with a feature (stopper) of the valve body 2 to limit the angular rotation of the regulatory body 6 to the second angular position where the second inlet orifice is aligned to face the gas inlet 4 to establish the second minimum flow.

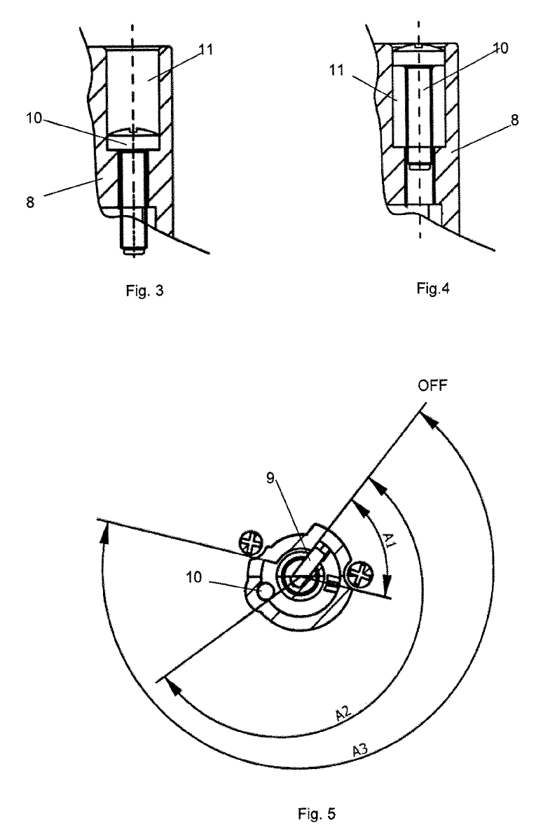

In accordance with one embodiment, and as shown in FIGS. 1, 3, 4 and 5, the stop element 10 of the regulation valve 1 can be arranged in an active position (FIG. 3) or in a rest position (FIG. 4). In the active position the stop element 10 cooperates with the drive shaft projection 9 to limit the angular rotation of the regulatory body 6 to the first angular position where the first inlet orifice is aligned to face the gas inlet 4. In the rest position the stop element 10 does not engage with projection 9, thereby permitting the regulatory body 6 to be rotated to the second angular position. In one implementation, the first angular position establishes a minimum flow rate of NG through the regulation valve 1 and the second angular position establishes a minimum flow rate of LPG through the regulation valve 1. At the free end of the drive shaft 7 there may be assembled a control knob (not shown in the drawings) that may be unique to the type of gas delivered through the regulation valve.

In a preferred embodiment, the stop element 10 is a screw. To standardize the number of components and reduce the cost of the regulation valve 1, the screw is the same as other screws used in the assembly of the regulation valve 1.

As shown in FIGS. 3 and 4, in one embodiment the housing 11 comprises a threaded section and an elongated section, so that the screw does not protrude from the valve body 2 when it is arranged in the rest position. In such an embodiment, placement of the stop element/screw is achieved by threading the screw through the threaded section of the housing 11. Such an arrangement inhibits the valve from being easily inadvertently tampered with in a way that would result in an improper flow of the second type of gas to a burner of a gas appliance.

FIG. 5 shows an example of different operating rotation angles “A” of regulatory body 6. From an OFF angular position (the regulation valve 1 being closed) the regulatory body 6 is rotatable in a clockwise direction to regulate the flow of gas between a maximum flow (Qₘₐₓ), intermediate flow (Qᵢₙₜ) and minimum flow (Qₘᵢₙ), depending on the rotated “A” angle. In selecting a minimum flow (Qₘᵢₙ) to be delivered to a burner of a gas burning appliance, the minimum flow for an NG type gas must be greater than the minimum flow for an LPG type gas for the burner to emit the same amount of heat in each instance.

In one embodiment, as shown in FIG. 5, the regulatory body 6 may rotate to a first angular position “A1” to supply a maximum flow (Qₘₐₓ) for both a first type of gas (e.g., NG) and a second type of gas (e.g., LPG). Continued rotation of the regulatory body 6 produces an intermediate flow (Qᵢₙₜ) through the regulation valve 1. The flow Qᵢₙₜ, being less than Qₘₐₓ. When the stop element 10 is in the active position, angular rotation of the regulatory body 6 is limited to the angular position “A2”. In this position the first radial inlet orifice of a calibrated diameter or surface area faces the gas inlet 4 and establishes a minimum flow for the NG type of gas. On the other hand, if the stop element 10 is in the rest position, angular rotation of the regulatory body 6 is not limited to angular position “A2” but is permitted to rotate to angular position “A3”. In this position the second radial inlet orifice of a calibrated diameter or surface area faces the gas inlet 4 and establishes a minimum flow for the second type of gas.

By virtue of the operating features of the regulation valve of the various embodiments disclosed herein, a NG gas burning appliance or a LPG gas burning appliance can be operate with the same regulation valve 1, thus avoiding a complicated adjustment of the regulatory body 6 and reducing the need for skilled personnel.

What is claimed is:

1. A regulation valve for supplying either a first type of gas or a second type of gas to a gas burner, the regulation valve comprising:
a valve body having a gas inlet,
a rotary regulatory body housed in said valve body, the regulatory body having a first inlet orifice corresponding to a first minimum flow of a first type of gas, and a second inlet orifice corresponding to a second minimum flow of a second type of gas, the first and second inlet orifices situated in the regulatory body at different angular positions, the first angular position preceding the second angular position,
a drive shaft attached to the rotary regulatory body, the drive shaft having a feature that cooperates with another part of the regulation valve to limit the angular rotation of the regulatory body to a second angular position where the second inlet orifice is aligned to face the gas inlet, and
a stop element associated with the valve body moveable between a rest position and an active position, in the active position the stop element interacts with the feature of the drive shaft to limit the angular rotation of the regulatory body to a first angular position where the first inlet orifice is aligned to face the gas inlet, in the rest position the stop element does not limit the angular rotation of the regulatory body to the first angular position, thereby permitting the regulatory body to be rotated to the second angular position.

2. A regulation valve according to claim 1, wherein the feature of the drive shaft is a radially extending projection.

3. A regulation valve according to claim 1, wherein the first type of gas is natural gas and the second type of gas is liquid petroleum gas.

4. A regulation valve according to claim 1, wherein the stop element is placed in a housing arranged in the valve body.

5. A regulation valve according to claim 1, wherein the stop element is a screw and the housing comprises a threaded section, the stop element being in an active position when the screw is threaded through the threaded section of the housing.

6. A regulation valve according to claim 5, wherein the housing comprises, before the threaded section, an elongated unthreaded first section, so that the screw does not protrude from the valve body when it is arranged in the rest position.

7. A regulation valve according to claim 1, wherein the valve body comprises a main body and a cover, on the cover being arranged a housing that receives the stop element.

8. A gas cooking appliance having a gas burner adapted for burning either a first type of gas or a second type of gas, the gas cooking appliance comprising at least one regulation valve for supplying either the first type of gas or the second type of gas to the gas burner, the regulation valve comprising a valve body having a gas inlet, a rotary regulatory body housed in said valve body, the regulatory body having a first inlet orifice corresponding to a first minimum flow of a first type of gas, and a second inlet orifice corresponding to a second minimum flow of a second type of gas, the first and second inlet orifices situated in the regulatory body at different angular positions, the first angular position preceding the second angular position, a drive shaft attached to the rotary regulatory body, the drive shaft having a feature that cooperates with another part of the regulation valve to limit the angular rotation of the regulatory body to a second angular position where the second inlet orifice is aligned to face the gas inlet, and a stop element associated with the valve body moveable between a rest position and an active position, in the active position the stop element interacts with the feature of the drive shaft to limit the angular rotation of the regulatory body to a first angular position where the first inlet orifice is aligned to face the gas inlet, in the rest position the stop element does not limit the angular rotation of the regulatory body to the first angular position, thereby permitting the regulatory body to be rotated to the second angular position.

9. A gas cooking appliance according to claim 1, wherein the feature of the drive shaft is a radially extending projection.

10. A gas cooking appliance according to claim 1, wherein the first type of gas is natural gas and the second type of gas is liquid petroleum gas.

11. A gas cooking appliance according to claim 1, wherein the stop element is placed in a housing arranged in the valve body.

12. A gas cooking appliance according to claim 1, wherein the stop element is a screw and the housing comprises a threaded section, the stop element being in an active position when the screw is threaded through the threaded section of the housing.

13. A gas cooking appliance according to claim 5, wherein the housing comprises, before the threaded section, an elongated unthreaded first section, so that the screw does not protrude from the valve body when it is arranged in the rest position.

14. A gas cooking appliance according to any claim 1, wherein the valve body comprises a main body and a cover, on the cover being arranged a housing that receives the stop element.
